(19) United States
(12) Patent Application Publication
(10) Pub. No.: US 2026/0073776 A1
(43) Pub. Date: Mar. 12, 2026

(54) LOTTERY TICKET SELLING SYSTEMS CONFIGURED TO EMPLOY PRINTED LOTTERY TICKET ROLLS

(71) Applicant: Brightstar Global Solutions Corporation, Providence, RI (US)

(72) Inventors: Paul Schneider, Jerome, ID (US); Christopher Lowrie, El Dorado Hills, CA (US)

(21) Appl. No.: 18/883,707

(22) Filed: Sep. 12, 2024

(51) Int. Cl. G07F 17/42; A63F 3/06; B41J 3/30; B41J 11/70; B41J 15/04

(52) U.S. Cl. CPC G07F 17/42; A63F 3/0655; B41J 3/30; B41J 11/70; B41J 15/046

(57) ABSTRACT

A lottery ticket printing apparatus and methods of operating the apparatus that enable the purchase of multiple draw lottery tickets by players, and the printing of the multiple draw lottery tickets in the form of a printed lottery ticket roll.

### BACKGROUND

The present disclosure relates to lottery ticket selling systems configured to employ printed lottery ticket rolls.

For a draw lottery ticket for a draw lottery game, a player may select the player numbers or may have an electronic lottery system randomly select the player numbers (which is often referred to as a quick pick). Draw lottery tickets may be purchased in variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates to a lottery ticket printing system including: a supply paper roll holder configured to support a removable lottery ticket paper roll; a lottery ticket printer; and a lottery ticket terminal comprising a processor and a memory device that stores a plurality of instructions, which when executed by the processor cause the processor to: determine a plurality of draw lottery tickets; and cause the lottery ticket printer to print the plurality of draw lottery tickets in a form of a printed lottery ticket roll using a lottery ticket paper roll supported by the supply paper roll holder.

In various other embodiments, the present disclosure relates to a lottery ticket retrieval device comprising: a housing; roll engagers supported by the housing and configured to advance a printed lottery ticket roll, wherein the printed lottery ticket roll comprises a plurality of printed draw lottery tickets; a controller including a processor and a memory device that stores a plurality of instructions, which when executed by the processor cause the processor to: receive ticket identifying information for a winning draw lottery ticket of the plurality of printed draw lottery tickets, and locate the winning draw lottery ticket on the printed lottery ticket roll, comprising causing the roll engagers to advance the printed lottery ticket roll to align the winning draw lottery ticket with a ticket retrieval location.

In various other embodiments, the present disclosure relates to a lottery ticket selling system comprising: a lottery ticket printer; and a lottery ticket terminal comprising a processor and a memory device that stores a plurality of instructions, which when executed by the processor cause the processor to: determine a plurality of draw lottery tickets for a plurality of different players; and cause the lottery ticket printer to print the plurality of draw lottery tickets in a form of a printed lottery ticket roll using a lottery ticket paper roll.

Additional features are described in, and will be apparent from, the following Detailed Description and the figures.

### BRIEF DESCRIPTION OF THE SEVERAL VIEWS OF THE DRAWINGS

FIG. 1A is front view of an example draw lottery ticket.

FIG. 1B is perspective view of an example stack of example draw lottery tickets that are printed on sheets of paper.

FIG. 2 is a diagrammatic view of a lottery ticket selling system including a player electronic device, a courier server, a lottery ticket roll handling device, a lottery terminal, and a lottery ticket printer in accordance with one example embodiment of the present disclosure.

FIG. 3 is a diagrammatic view of the lottery terminal of FIG. 2 in accordance with one example embodiment of the present disclosure.

FIG. 4 is a diagrammatic view of the lottery ticket printer of FIG. 2 and a printed lottery ticket roll in accordance with one example embodiment of the present disclosure.

FIG. 5 is a diagrammatic view of the printed lottery ticket roll of FIG. 4 and the ticket roll handling device of FIG. 2 in accordance with one example embodiment of the present disclosure.

FIG. 6 is front view of part of the example printed lottery ticket roll of FIG. 4 in accordance with one example embodiment of the present disclosure.

FIG. 7 is a flow diagram showing one example method of operation of the lottery ticket selling system of FIG. 2 in accordance with one example embodiment of the present disclosure.

### DETAILED DESCRIPTION

In various embodiments, the present disclosure relates to a lottery ticket selling system and methods of operating the lottery ticket selling system, wherein the lottery ticket selling system includes a supply paper roll holder that supports replaceable paper rolls, a lottery ticket terminal, a lottery ticket printer, and a lottery ticket retrieval device. The lottery ticket selling system enables the purchase of multiple draw lottery tickets for players, the printing of the multiple draw lottery tickets in the form of a printed lottery ticket roll, and efficient retrieval of winning draw lottery tickets from the printed lottery ticket roll.

In various embodiments, the present disclosure provides a lottery ticket selling system including a paper roll supporter that supports replaceable paper rolls, a lottery ticket terminal, a lottery ticket printer, and a lottery ticket retrieval device. The lottery ticket terminal determines a plurality of draw lottery tickets and causes the lottery ticket printer to print the plurality of draw lottery tickets in the form of a printed lottery ticket roll using a lottery ticket paper roll supported by the supply paper roll holder. The lottery ticket retrieval device is configured to retrieve each necessary winning draw lottery ticket from the printed lottery ticket roll using ticket identifying information for that winning draw lottery ticket.

In various embodiments, the printed lottery ticket roll includes multiple draw lottery tickets that are purchased by or for different players (and thus owned by different players) and that are physically attached to each other. In various embodiments, the printed lottery ticket roll includes a continuous strip of lottery ticket paper having the multiple draw lottery tickets printed thereon. In various embodiments, the printed lottery ticket roll also includes printed location data (or suitable indicators) that is scannable by a suitable reader and facilitates the identification of locations on the printed lottery ticket roll that are associated with the multiple draw lottery tickets. That is, the printed location data (or suitable indicators) can identify where, within a printed lottery ticket roll, a particular printed draw lottery ticket is located.

In various embodiments, the present disclosure provides a lottery ticket terminal including a housing, a supply paper roll holder supported by the housing, a lottery ticket printer, and a controller. The lottery ticket terminal receives lottery ticket information for each of multiple draw lottery tickets, generates ticket printer data based on the lottery ticket information for the multiple draw lottery tickets, and causes the lottery ticket printer to print the multiple draw lottery tickets in the form of a printed lottery ticket roll based on the ticket printer data and using a lottery ticket paper roll supported by the paper roll holder.

In various embodiments, the lottery ticket terminal also includes a lottery ticket roll handling device that receives the paper of the printed lottery ticket roll and wraps the paper of the printed lottery ticket roll around a replaceable spool.

In various embodiments, the lottery ticket terminal also includes a lottery ticket retrieval device that receives a replaceable spool holding a printed lottery ticket roll, receives ticket identifying information for a winning draw lottery ticket on the printed lottery ticket roll, and retrieves the winning draw lottery ticket from the printed lottery ticket roll using the ticket identifying information.

In various embodiments, the lottery ticket terminal also tracks and stores location data that identifies locations on the printed lottery ticket roll at which the printed draw lottery tickets can be retrieved.

In various embodiments, the lottery ticket terminal also tracks location data that identifies locations on the printed lottery ticket roll at which the printed draw lottery tickets can be retrieved and prints the location data on the printed lottery ticket roll.

In various embodiments, the present disclosure provides a lottery ticket retrieval device. The lottery ticket retrieval device is configured to: (1) receive a replaceable spool holding a printed lottery ticket roll; (2) receive ticket identifying information for a winning draw lottery ticket; and (3) retrieve the winning draw lottery ticket from the printed lottery ticket roll.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for purchasing and redeeming such various other draw lottery tickets.

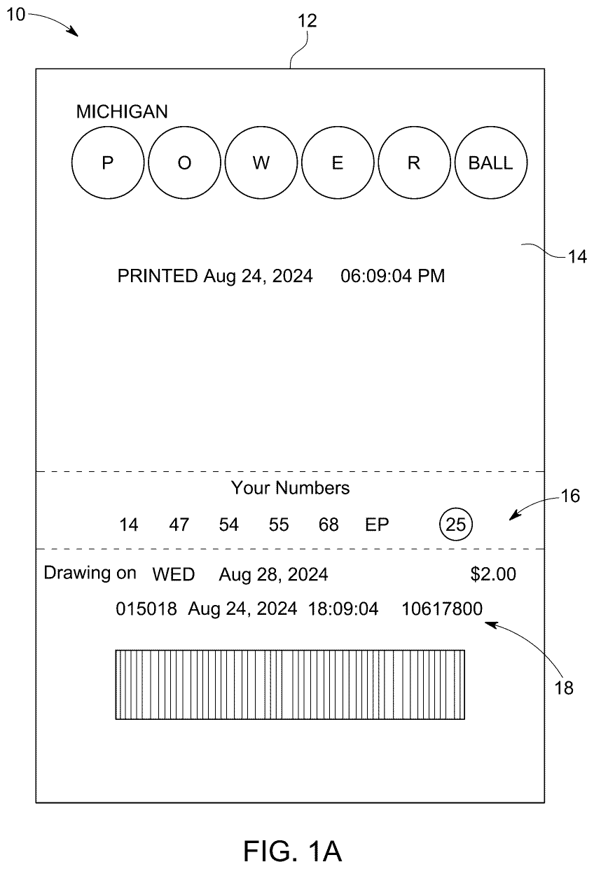

An example physical draw lottery ticket 10 is shown in FIG. 1A. This example draw lottery ticket includes: (1) a ticket substrate 12; (2) a front surface 14 of the ticket substrate 12; (3) a single set of player numbers (for a single play of draw lottery game) printed on the front surface 14 of the ticket substrate 12; (4) a back surface (not shown) of the ticket substrate 12; and (5) lottery game and ticket information (not labeled) printed on the front surface 14 of the ticket substrate 12. This example draw lottery ticket 10 is for a single play of a draw lottery game (scheduled to take place on Wednesday Aug. 28, 2024) and includes a single set of player numbers 16 (i.e., player numbers for the single play of the draw lottery game). It should be appreciated that while this draw lottery ticket is for a single play, draw lottery tickets often include multiple sets of player numbers that are for a single play of the draw lottery game. The lottery ticket information can include text, one or more ticket numbers (shown as ticket identifier 18), one or more ticket barcodes, and other lottery ticket information that is in either or both human readable and machine readable forms. The lottery ticket's barcode is configured to be scanned by a barcode reading device to enable redemption of such draw lottery ticket.

Additionally, for a better understanding of the present disclosure, various known systems and methods employed for purchasing draw lottery tickets are also now described.

In a first example known lottery ticket system and method for purchasing a draw lottery ticket for a draw lottery game in person, a player selects the player numbers for the draw lottery ticket and the player fills out a paper play slip with the player's selected numbers. The player hands that play slip to an operator of a lottery terminal and the operator causes the operator uses a lottery terminal including a contact image sensor (CIS) reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers. The lottery terminal and specifically the terminal application causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player. It should be appreciated that in certain such systems, the lottery terminal includes the CIS reader and the lottery ticket printer in one cabinet. In other systems, the CIS reader and/or the lottery ticket printer can be separate from the lottery terminal cabinet and connected to the lottery terminal by suitable wires.

In a slight variation of this first example known lottery ticket system and method for purchasing a draw lottery ticket for a draw lottery game in person, a player does not select the player numbers for the draw lottery ticket and the player marks a paper play slip with an indication of a requested quick pick for the player numbers. The player hands that play slip to an operator of a lottery terminal and the operator uses a lottery terminal including a CIS reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers. In this case, the lottery terminal randomly generates the player numbers. The lottery terminal and specifically the terminal application causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player.

In a second example known lottery ticket system and method for purchasing a draw lottery ticket for a draw lottery game in person, a player does not fill out a paper play slip with the player's selected numbers, but rather the player tells the operator of a lottery terminal that the player wants to purchase a draw lottery ticket using a quick pick for a draw lottery game and the operator inputs that request into the lottery terminal (via an operator interface of the lottery terminal). The lottery terminal randomly determines the player numbers for the player's lottery ticket for the play of the lottery game and uses those numbers to create a draw lottery ticket. The lottery terminal then causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player.

In a third example known lottery ticket system and method for purchasing a draw lottery ticket for a draw lottery game in person, a player uses a suitable application on a player's computer such as a player mobile electronic device (such as a smartphone) to fill out an electronic play slip displayed by the player's computer with the player's selected numbers for the draw lottery game or a quick pick. The application creates a barcode displayable by the display device of the player mobile electronic device. The player causes their mobile electronic device to display the barcode such that a CIS reader of a lottery terminal having a barcode scanner scans the barcode and creates player slip scan data representing the player numbers or the quick pick for the play of the draw lottery game. The CIS reader sends the player slip scan data to a terminal application of the lottery terminal, and the terminal application uses that player slip scan data to create a draw lottery ticket including the player numbers (respectively either selected by the player or randomly selected by the lottery terminal). The lottery terminal causes a lottery ticket printer to print out the draw lottery ticket with the player numbers. The operator of the lottery terminal also collects the payment for the draw lottery ticket and provides the printed draw lottery ticket to the player.

In a fourth example known lottery ticket system and method for purchasing a draw lottery ticket for a draw lottery game remotely (from any lottery terminal), a player uses their computer such as a player mobile electronic device (such as a smartphone) to access a web site to fill out an electronic play slip with the player numbers (selected by the player or randomly selected by the web site) for the draw lottery game. The web site functions with a lottery host system to create a draw lottery ticket including the player numbers. The web site also functions with a lottery host system to obtain payment for the draw lottery ticket including the player numbers. The lottery host system creates a virtual draw lottery ticket with the player numbers for the player and sends that virtual draw lottery ticket to an email address of the player. This fourth example known system does not include any lottery terminal (or CIS reader thereof).

This fourth example known lottery ticket system is only legal in a limited quantity of jurisdictions (such as states in the United States) that permit the purchase of draw lottery tickets via such completely remote and electronic systems and methods.

In various other jurisdictions (such as other states) that do not permit such completely remote and electronic purchase of draw lottery tickets (such as via the above described fourth example known system and method), a fifth example known lottery ticket system using a courier service has been employed. This fifth example known lottery ticket system and method has been used to enable players to remotely electronically purchase draw lottery tickets for draw lottery games wherein the courier service conducts various physical steps of the lottery ticket purchase process on behalf of the players. More specifically, in this fifth example known system and method for purchasing a draw lottery ticket for a draw lottery game remotely from any lottery terminal, a player uses a suitable application on their mobile electronic device (such as mobile telephone) to purchase a draw lottery ticket (which can include the player inputting the player's selected numbers or a quick pick indication for the draw lottery game). This application is often referred to as a courier mobile application. The courier mobile application functions to create lottery ticket purchase data (including the player's selected numbers or the quick pick numbers that the courier mobile application randomly selected) and causes the player's mobile electronic device to send the lottery ticket purchase data via a data network to a courier server at a courier processing center. The courier server uses the received lottery ticket purchase data to create and cause a courier printer to physically print a physical paper play slip for the play of the draw lottery game at the courier processing center. The play slip includes the player numbers. A human courier processing clerk takes the physical printed paper play slip for the play of the draw lottery game to an operator of a lottery terminal at a physical location of the lottery terminal that is remote from the courier processing center. The operator uses the lottery terminal (which includes a CIS reader) to scan the physical printed paper play slip. The CIS reader creates play slip scan data for the draw lottery ticket, and the terminal application of the lottery terminal uses that play slip scan data to determine the player numbers for the play of the draw lottery game and to create the lottery ticket (such as in the same manner as described above for the first example). The lottery terminal causes a lottery ticket printer to print out the draw lottery ticket with the player numbers. The operator of the lottery terminal also collects the payment for the draw lottery ticket from the courier processing clerk and provides the printed draw lottery ticket to the courier processing clerk. The courier processing clerk then takes the physical printed play slip and the physical printed draw lottery ticket back to the courier processing center. The courier processing clerk scans the physical printed draw lottery ticket using a courier scanning system connected to the courier server. The courier server links the scanned draw lottery ticket back to a player account established through the courier mobile application. The courier server then makes the scanned draw lottery ticket available for the player to view via the courier mobile application on the player's mobile electronic device. The courier processing clerk places the physical printed play slip and the physical printed draw lottery ticket in secure courier storage locations for storage if needed at a later time. After the draw for the play of the draw lottery game takes place, if the player's draw lottery ticket is a winning draw lottery ticket and the winning amount is less than $600, the courier server automatically credits the winning amount for the player's draw lottery ticket to the player's account. The courier service can then retrieve and redeem the stored actual winning physical printed draw lottery ticket at a location having a lottery terminal. After the draw for the draw lottery game takes place, if the player's draw lottery ticket is a winning lottery ticket and the winning amount is $600 or more, a courier processing clerk retrieves the stored winning physical player draw lottery ticket from the courier storage location and sends that physical printed draw lottery ticket to the player so that the player can cash in that draw lottery ticket and obtain the winning amount.

Turning to FIG. 1B, an example stack of printed draw lottery tickets is shown. As described above, printed draw lottery tickets obtained for ticket purchasers via the courier service are physically transported from the lottery terminal by the courier processing clerk and taken to the courier processing center for storage. When the courier service is provided to hundreds or even thousands of ticket purchasers, a large quantity of individual printed draw lottery tickets are transported and stored (such as in the form of the stack of draw lottery tickets shown in FIG. 1B). The courier processing clerk can place stacks of such draw lottery tickets in boxes (e.g., a box or set of boxes for a particular draw date of a particular draw lottery game), with the boxes placed in a secure storage for retrieval in the event that an individual printed draw lottery ticket within a box is a winning draw lottery ticket and must be presented for redemption.

For redemption of a winning draw lottery ticket, the courier processing clerk retrieves the box in which the winning draw lottery ticket is located from storage. The courier processing clerk examines the individual printed draw lottery tickets within that box to locate the winning draw lottery ticket, for example, by examining the player numbers or other information on the printed draw lottery tickets. Even when the printed draw lottery tickets within a same box are for a same draw date, the player numbers or other information may not be in any particular order, especially where the stack of printed draw lottery tickets has shifted during transportation and/or storage. The courier service processes are time consuming, labor intensive, and due to the multiple steps can be more prone to errors (such as human errors). When the top award for a draw lottery game reaches a relatively large amount, there is often an increase in play of that draw lottery game, and such courier services often have a difficult time keeping up with the demand especially due to the need to physically store the printed draw lottery tickets.

The present disclosure provides a lottery ticket selling system and method that improves upon the above described courier service processes and overcomes numerous of these disadvantages while still providing many of the advantages of the courier service processes, and while expected to be permitted by the various state lotteries that permit such courier services.

Various embodiments of the present disclosure employ an example lottery ticket terminal to improve upon these processes as described below.

A printed lottery ticket roll is used as an example herein, however, it should be appreciated that the present disclosure contemplates that other physical printed formats of media for multiple lottery tickets besides the printed lottery ticket roll can be employed in accordance with the present disclosure.

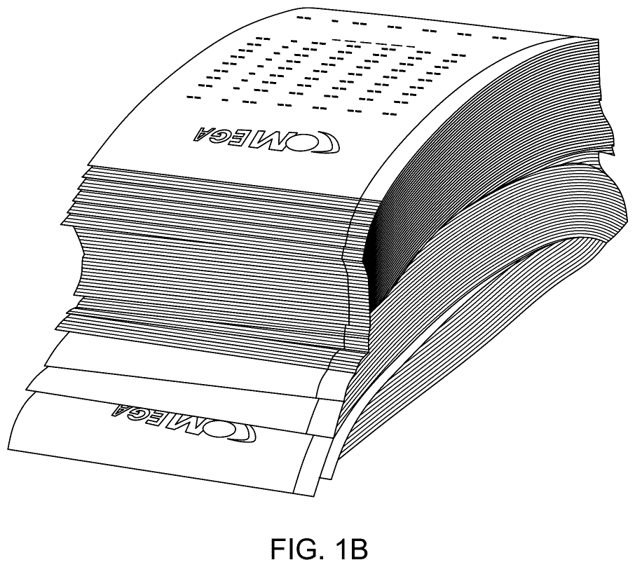

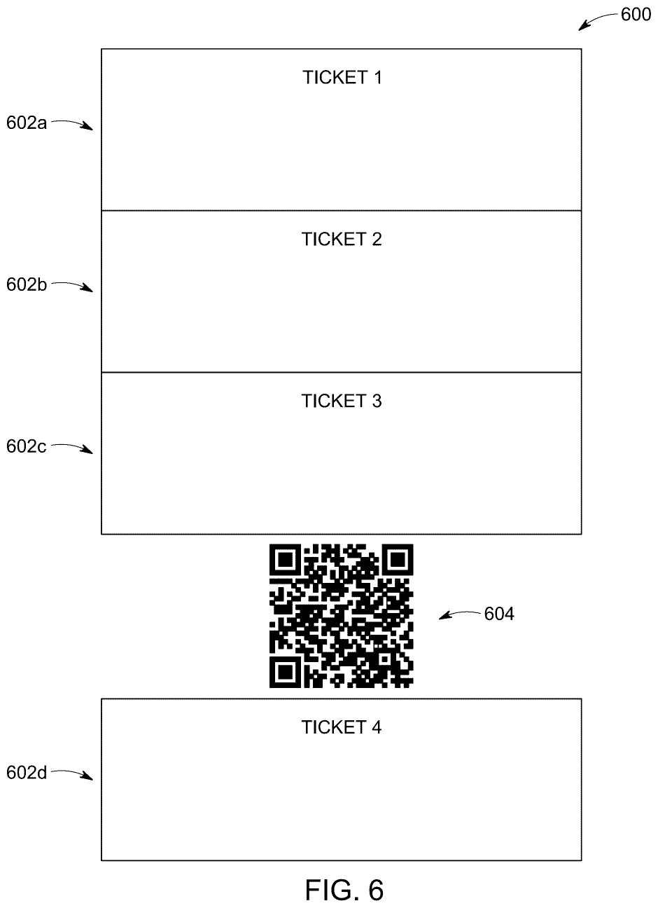

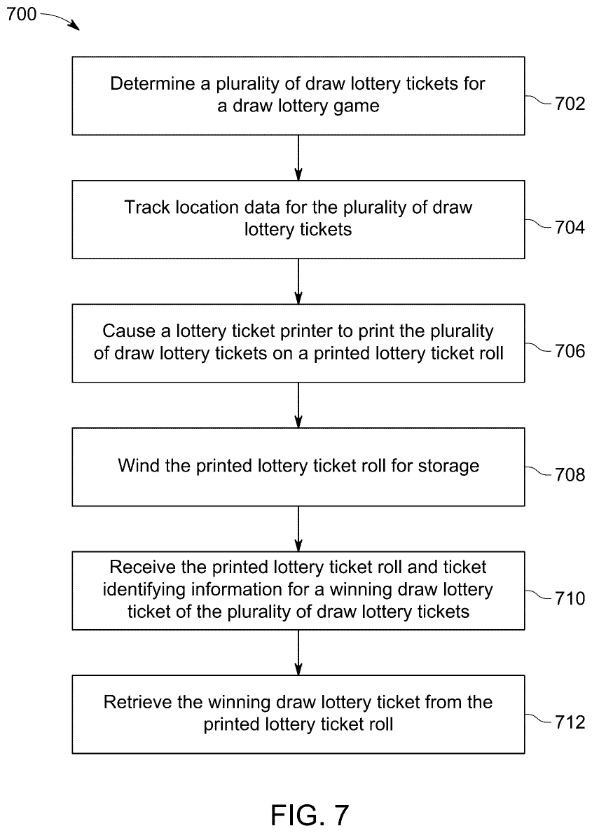

FIGS. 2, 3, 4, and 5 illustrate an example lottery ticket selling system 100 of one example embodiment of the present disclosure. FIG. 6 illustrates an example printed lottery ticket roll of one example embodiment of the present disclosure. FIG. 7 illustrates an example method 700 of operating the example lottery ticket selling system 100 in accordance with one example embodiment of the present disclosure.

More specifically, this illustrated example embodiment of the present disclosure provides a lottery ticket selling system 100 including: (a) a player electronic device 110 with a courier mobile application downloaded thereon; (b) a courier server 130; (c) a lottery terminal 140; (d) a lottery ticket printer 150; (e) a lottery ticket roll handling device 160; (f) a lottery ticket retrieval device 180; and (g) a central lottery server 200. For ease of description, the example lottery ticket selling system 100 as shown in FIG. 2 includes the lottery terminal 140, the lottery ticket printer 150, the lottery ticket roll handling device 160, and the lottery ticket retrieval device 180 as separate devices. In other embodiments, two or more of the lottery terminal 140, the lottery ticket printer 150, the lottery ticket roll handling device 160, and the lottery ticket retrieval device 180 can be combined within a same housing. Various embodiments of the present disclosure are directed to the lottery terminal 140 itself and methods of operation thereof. Various embodiments of the present disclosure are directed to the lottery terminal 140 and the lottery ticket printer 150 (in a same housing or different housings), and methods of operation thereof. Various other embodiments of the present disclosure are directed to the lottery ticket retrieval device 180 and methods of operation thereof. Various embodiments of the present disclosure are directed to the lottery terminal 140 and the lottery ticket retrieval device 180 (in a same housing or different housings) and methods of operation thereof. Various embodiments of the present disclosure are directed to the lottery terminal 140, the lottery ticket printer 150, and the lottery ticket roll handling device 160 (in a same housing or different housings), and methods of operation thereof.

In this illustrated example embodiment, the player electronic device 110 and the courier server 130 are configured to communicate with each other via a suitable data network 120 such as but not limited to a cellular data network or the Internet.

In this illustrated example embodiment, the lottery terminal 140 and the lottery ticket printer 150 are configured to communicate with each other via hard wire such as an USB connector. In other embodiments, the communication between these components can be via a suitable data network. In other embodiments, the lottery ticket printer 150 can be built into the same housing as the lottery terminal 140 and thus be physically connected by hard wires.

In this illustrated example embodiment, the lottery terminal 140 and the lottery central system 200 are configured to communicate with each other via a suitable data network 170 such as a cellular data network, the Internet, or a private secure network.

More specifically, the player electronic device 110 with the courier mobile application downloaded thereon can be any suitable device such as an electronic smartphone, an electronic tablet, an electronic watch, or other suitable electronic computing device with suitable data communication, user input, and display functions. The courier mobile application downloaded on the player electronic device 110 can be the exact same commercially available courier mobile application as described above in connection with the fifth example or can be any other suitable courier mobile application. The courier mobile application is configured to enable a player to use the courier mobile application on the player electronic device 110 to set up a player account with the courier service, to deposit funds to the player account, to withdraw funds from the player account, and to use funds in the player account to purchase a lottery ticket for a draw lottery game via the courier mobile application (which can include the player inputting the player's selected numbers or a quick pick request for the draw lottery ticket for the draw lottery game that the player wishes to purchase and thus play). The courier mobile application functions on the player electronic device 110 to create lottery ticket purchase data (including the player selected numbers or the quick pick numbers) and cause the player electronic device 110 to send the lottery ticket purchase data via the data network 120 to the courier server 130 that is located at a suitable courier processing center (not shown).

The courier server 130 is a suitable server configured to perform at least the various functions described herein. More specifically, the courier server 130 is configured to receive lottery ticket purchase data from the player electronic device 110 via the courier mobile application and to create a suitable play slip for the draw lottery game based on the lottery ticket purchase data. The play slip includes lottery ticket information, such as the player's selected numbers or the quick pick numbers for the selected play of the selected draw lottery game. Play slip(s) are provided to the lottery terminal 140 for printing of draw lottery tickets, as described below.

In various embodiments, the courier server 130 generates the play slip as digital play slip image data (such as in the form of a bit map) and sends that digital play slip image data for the draw lottery game to the lottery terminal 140.

In various embodiments, the courier server 130 generates the play slip as a physical printed paper play slip, as described above in connection with the fifth example or can be any other suitable physical paper play slip. That is, a human courier processing clerk takes the physical printed paper play slip for the play of the draw lottery game to an operator of the lottery terminal 140.

In various embodiments, the courier server 130 hosts a web site that enables a player to use their computer (e.g., the player mobile electronic device) to fill out an electronic play slip with the player numbers (selected by the player or randomly selected by the web site) for the draw lottery game. The courier server 130 sends the electronic play slip to the lottery terminal 140.

In various embodiments and/or scenarios, the courier server 130 generates a play slip to include: (1) ticket information for a single draw lottery ticket; (2) ticket information for multiple draw lottery tickets for a same lottery game and for a same user; (3) ticket information for multiple draw lottery tickets for a same lottery game for multiple users; (4) ticket information for multiple draw lottery tickets for different lottery games for a same user; and/or (5) ticket information for multiple draw lottery tickets for different lottery games and for multiple users. In other words, the play slip can be associated with one, two, three, or more draw lottery tickets for one, two, three or more draw lottery games for one, two, three or more users. In various embodiments, the courier server 130 generates a play slip for multiple draw lottery tickets by combining ticket information for multiple users to create a single play slip. In some such embodiments, the courier server 130 combines ticket information for draw lottery tickets that are only for a same lottery game to enable printing of those draw lottery tickets on a same printed lottery ticket roll.

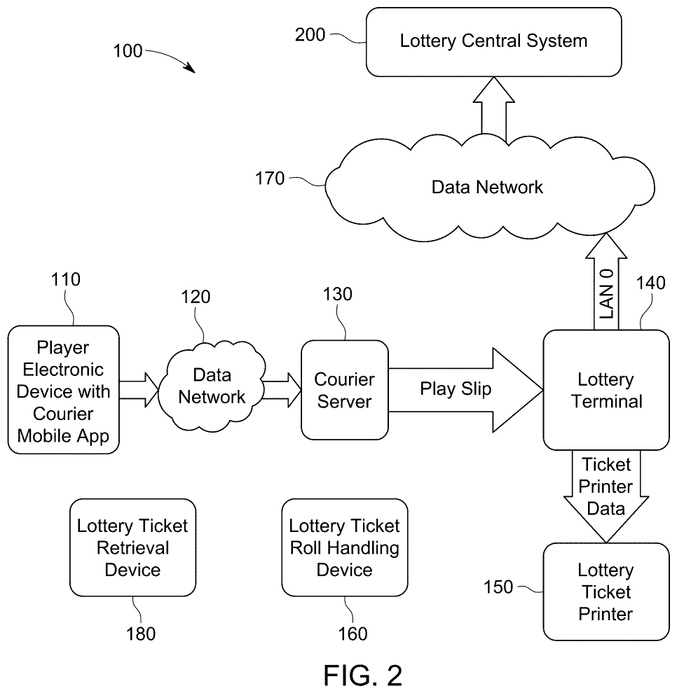

In the example embodiment shown in FIG. 2 and FIG. 3, the lottery terminal 140 includes a controller 300. In various embodiments, the controller 300 includes a processor and a memory (not shown). The memory includes instructions that when executed by the processor cause and/or configure the processor to provide functionality as described herein. In various embodiments, the controller 300 includes a ticket printing module 310 that is stored in the memory and includes the instructions. In other embodiments, all or a portion of the controller 300 can be implemented using application-specific integrated circuits or other suitable hardware.

The lottery terminal 140 is configured to generate draw lottery tickets and cause the lottery ticket printer 150 to print the draw lottery tickets in the form of a printed lottery ticket roll 400 using a blank paper roll 420 such as described below. In various embodiments, the controller 300 is configured to process ticket information based on a play slip for purchasing and printing of draw lottery ticket(s) associated with the play slip. The play slip can be a physical paper play slip, digital play slip data, and/or an electronic play slip, as described above. The controller 300 is configured to generate ticket printer data based on the play slip for the lottery ticket printer 150. The ticket printer data includes data and/or instructions that cause the lottery ticket printer 150 to print onto the blank paper roll 420 thereby creating a printed lottery ticket roll 400 such as described below. In various embodiments, the controller 300 is configured to combine ticket information for multiple draw lottery tickets and generates suitable ticket printer data for the multiple draw lottery tickets to be printed on a same printed lottery ticket roll. In various embodiments, the controller 300 is configured to suppress a ticket cutting feature of the lottery ticket printer 150 to enable multiple draw lottery tickets to be printed on the same printed lottery ticket roll without separating the draw lottery tickets from each other.

In various embodiments, the lottery terminal 140 is configured to track location data (or other indicators) that facilitate(s) identifying locations on the printed lottery ticket roll 400 at which the printed draw lottery tickets can be retrieved. In various embodiments, the lottery terminal 140 stores the location data for use when retrieving a winning lottery ticket from the printed lottery ticket roll 400. That is, the stored location data is retrievable by the lottery terminal 140 or other suitable entity when retrieving a lottery ticket from the printed lottery ticket roll 400.

In various embodiments, the lottery terminal 140 prints the location data on the printed lottery ticket roll 400. In various embodiments, the lottery terminal 140 causes the printed location data to be printed at one end of the printed lottery ticket roll 400 (i.e., a last portion of the printed lottery ticket roll 400 to be printed and thus a first portion to be unwound for faster location of a ticket). In various embodiments, the printed location data is interleaved with the printed draw lottery tickets (e.g., after every tenth lottery ticket). That is, the printed lottery ticket roll 400 includes multiple, separate sections of printed location data.

In various embodiments, all or a portion of the printed location data is encoded (such as via a QR code to reduce its printed size on the printed lottery ticket roll 400). In certain such embodiments, the encoded location data is scannable and decodable by a suitable data scanning device, such as a barcode reader, QR code reader, image capture device on a smartphone, etc. In various embodiments, all or a portion of the printed location data is human readable (e.g., to simplify identification of the printed lottery ticket roll 400 by a courier processing clerk). While QR codes and barcodes are employed as examples herein, the codes employed can be other suitable codes.

In various embodiments, the location data indicates which draw lottery tickets are printed on the printed lottery ticket roll 400 and a location at which those printed draw lottery tickets can be retrieved. In various embodiments, the location data includes a listing of ticket identifiers (e.g., unique serial numbers) and seek information associated with each draw lottery ticket printed on the printed lottery ticket roll 400. For each draw lottery ticket, the seek information for a ticket identifier can include: (1) a quantity of rotations to unwind the printed lottery ticket roll 400 to reach that ticket (e.g., sixteen rotations); (2) a ticket index that indicates an ordered placement of that ticket on the printed lottery ticket roll 400 (e.g., the seventh ticket printed on roll); (3) a distance metric associated with an amount of the printed lottery ticket roll 400 to unwind to reach that ticket (e.g., unwind 30 inches of paper to reach that particular ticket); and/or (4) other suitable information. In various embodiments, the seek information includes an absolute location, such as a distance metric of 30 inches from the end of the printed lottery ticket roll 400. In various embodiments, the seek information includes a relative location, such as a distance metric of 22 inches relative to a location at which the seek information is printed.

In various embodiments, the location data is based on draw lottery tickets that have a same ticket size. As one example where each draw lottery ticket is two inches in length, location data for the first ticket indicates a location at zero inches (or another suitable starting location), location data for the second ticket indicates a location at two inches, location data for the third ticket indicates a location at four inches, etc. In various other embodiments, the location data is based on a variable ticket size, for example, when a single draw lottery ticket can include multiple sets of player numbers.

The above described lottery terminal is one example lottery terminal that the present disclosure can be employed with. It should be appreciated that the present disclosure can be employed with other suitable lottery terminals.

The blank paper roll 420 can be any suitable roll of lottery ticket paper on which draw lottery tickets can be printed by the lottery ticket printer 150. That is, the blank paper roll 420 does not have any lottery tickets printed on it. The blank paper roll 420 is referred to herein as the paper roll 420 for brevity. In various embodiments, the paper roll 420 includes one or more security features, such as a watermark feature or other suitable security feature. In certain embodiments and/or scenarios, the blank paper roll 420 can be wound around a spool.

After printing of draw lottery ticket(s) onto the paper roll 420, the roll is referred to herein as the printed lottery ticket paper roll 400. That is, the printed lottery ticket paper roll 400 includes a continuous strip of lottery ticket paper having the multiple draw lottery tickets printed thereon. In certain embodiments and/or scenarios, the printed lottery ticket roll 400 can be wound around a spool.

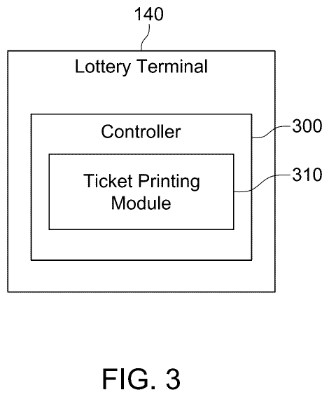

As described above, the paper roll 420 and/or the printed lottery ticket roll 400 can be supported by a spool, such as the example spool 402 shown in FIG. 4. In various embodiments, the printed lottery ticket roll 400 is supported by another suitable holder and/or wrapped with a band (e.g., a paper band connected to itself with adhesive or a rubber band). In various embodiments, when used with the spool 402, the printed lottery ticket roll 400 is wound around the spool 402 by the lottery ticket printer 150, the lottery ticket roll handling device 160, and/or the lottery ticket retrieval device 180. The spool 402 facilitates winding and unwinding of the printed lottery ticket roll 400 (e.g., when printing and/or locating a lottery ticket), handling of the printed lottery ticket roll 400, and/or storage of the printed lottery ticket roll 400. In various embodiments, the spool 402 can include: (a) one or more rims (e.g., flanges) that improve alignment and/or feeding of the printed lottery ticket roll 400; (b) one or more drive surfaces that improve engagement with roll engagers; and/or (c) one or more suitable roll retention devices (not shown). The roll retention device can include a slot in the spool 402 (e.g., extending between the flanges) through which an end of the printed lottery ticket roll 400 is insertable. The roll retention device facilitates winding of the printed lottery ticket roll 400 by reducing slippage of the printed lottery ticket roll 400 about the spool 402.

The example lottery ticket printer 150 shown in FIG. 2 and FIG. 4 includes: (a) a printer housing 410; (b) a supply paper roll holder 412; (c) a plurality of roll engagers (not shown) supported by the printer housing 410; and (d) a controller (not shown). The size and configuration of the lottery ticket printer 150 can vary in accordance with the present disclosure. The example lottery ticket printer 150 is configured to receive ticket printer data from the lottery terminal 140 and process the ticket printer data by the controller to advance the paper roll 420 from the supply paper roll holder 412 through a printing path and print multiple lottery tickets onto a same printed lottery ticket roll, such as the printed lottery ticket roll 400. In various embodiments, the lottery ticket printer 150 outputs the printed lottery ticket roll 400 as: (1) an unwound, unsupported strip of paper; (2) a wound, unsupported strip of paper; or (3) a wound, supported strip of paper that is supported by a spool and/or band.

The supply paper roll holder 412 includes a spindle, a curved tray or recess, or other suitable holder for supporting the paper roll 420. In various embodiments, the lottery ticket printer 150 includes multiple supply paper roll holders that support multiple paper rolls (e.g., to support paper rolls for different lottery games and/or additional printing capacity). In various embodiments, the lottery ticket printer 150 includes one or more printed paper roll holders, analogous to the supply paper roll holder, that support printed lottery ticket rolls, such as the printed lottery ticket roll 400.

The roll engagers of the lottery ticket printer 150 can include one or more driven spindles, guide spindles, driven rollers, guide rollers, or other suitable components. In various embodiments, the roll engagers of the lottery ticket printer 150 engage the paper roll 420 and/or the printed lottery ticket roll 400 directly. In various embodiments, the roll engagers of the lottery ticket printer 150 engage the rolls directly and also engage one or more spools that support the paper roll 420 and/or the printed lottery ticket roll 400 (e.g., for winding and/or unwinding).

The example lottery ticket roll handling device 160 includes a printed paper roll holder (not shown) that supports a printed lottery ticket roll, such as a spindle, a curved tray or recess, or other suitable holder. In various embodiments, the lottery ticket roll handling device 160 includes roll engagers (not shown) that advance and/or guide the printed lottery ticket roll. In various embodiments, the lottery ticket roll handling device 160 includes a paper inlet port (not shown) configured to receive and/or guide the printed lottery ticket roll 400 (e.g., along a paper winding path). The lottery ticket roll handling device 160 is configured to receive and wind a printed lottery ticket roll 400 for storage, as described below.

The example lottery ticket retrieval device 180 includes: (a) a housing 182; (b) a printed paper roll holder 183 supported by the housing 182; (c) a code reader 184; (d) a plurality of roll engagers 186 supported by the housing 182; and (e) a controller (not shown). The size and configuration of the lottery ticket retrieval device 180 can vary in accordance with the present disclosure. In various embodiments, the lottery ticket retrieval device 180 is configured to receive a printed lottery ticket roll 400, receive ticket identifying information that identifies a winning draw lottery ticket on the printed lottery ticket roll 400, and retrieve the winning draw lottery ticket from the printed lottery ticket roll 400.

The printed paper roll holder 183 includes a spindle, a curved tray or recess, or other suitable holder for supporting the printed lottery ticket roll 400. In various embodiments, the lottery ticket retrieval device 180 includes multiple printed paper roll holders. In certain such embodiments, different printed paper roll holders are configured to hold printed lottery ticket rolls 400 to be processed one after another by the lottery ticket retrieval device 180.

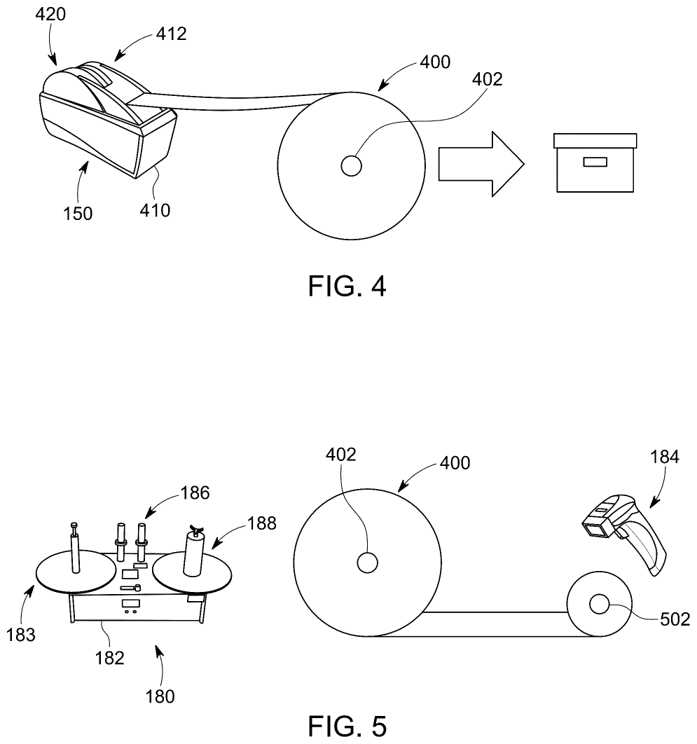

In various embodiments, the code reader 184 is configured to scan printed location data from a printed lottery ticket roll 400. In various embodiments, the code reader 184 includes a QR code reader, a barcode reader, an image sensor, or other suitable data reader that is communicatively coupled with the lottery ticket retrieval device 180 via a wired and/or wireless interface. In the example shown in FIG. 5, the code reader 184 includes a handheld QR code scanner that is connected by a wire or that is wirelessly coupled with the lottery ticket retrieval device 180. In various embodiments, the code reader 184 is integral with the lottery ticket retrieval device 180 (i.e., supported by the housing 182).

In various embodiments, the code reader 184 is configured to scan printed lottery tickets on the printed lottery ticket roll 400. In some such embodiments, the lottery ticket retrieval device 180 is configured to track location data based on scanned lottery ticket data from the code reader 184, for example, when the printed lottery ticket roll 400 does not already include printed location data. In other words, the lottery ticket retrieval device 180 tracks the location data independently of the lottery terminal 140. In various embodiments, the lottery ticket retrieval device 180 stores the location data for use when retrieving a winning lottery ticket from the printed lottery ticket roll 400. In various embodiments, the lottery ticket retrieval device 180 uses a printer (not shown) to print the location data to the printed lottery ticket roll 400 (e.g., at an end of the roll, on a back surface of the roll, etc.).

The roll engagers 186 can include one or more driven spindles, guide spindles, driven rollers, guide rollers, and/or other components configured to guide, advance, and/or rewind the printed lottery ticket roll 400. In various embodiments, the roll engagers 186 engage the spool about which the printed lottery ticket roll 400 is wound.

In various embodiments, the lottery ticket retrieval device 180 includes a ticket cutter (not shown) supported by the housing 182 and configured to cut a draw lottery ticket from the printed lottery ticket roll 400. In these embodiments, the lottery ticket retrieval device 180 causes the roll engagers to advance the printed lottery ticket roll to align the draw lottery ticket with a ticket retrieval location and the ticket cutter is configured to cut lottery tickets aligned with the ticket retrieval location. In various embodiments, the lottery ticket retrieval device 180 includes a ticket dispensing port through which the roll engagers 186 dispense a cut draw lottery ticket.

In various embodiments, the lottery ticket retrieval device 180 includes an output paper roll holder, such as output paper roll holder 188, configured to receive a remainder of the printed lottery ticket roll 400. In various embodiments, the lottery ticket retrieval device 180 includes multiple output paper roll holders configured to receive remainders of different printed lottery ticket rolls.

In various embodiments, the lottery ticket retrieval device 180 includes a splicing device (not shown) that facilitates handling of the remainder of the printed lottery ticket roll 400. The splicing device is configured to join a cut paper section of a printed lottery ticket roll to another paper section, for example, by using adhesive tape, applying adhesive to the section(s) to be joined, and/or crimping the section(s) to be joined.

In various embodiments, the lottery ticket retrieval device 180 includes one or more user interface components (not shown), such as a keypad or touch screen display, that enable a user to enter ticket identifying information for a winning draw lottery ticket.

In various embodiments, the lottery ticket retrieval device 180 is communicatively coupled with the courier server 130. For example, the lottery ticket retrieval device 180 is configured to provide to the courier server 130 scanned location data and/or scanned ticket data based on the printed lottery ticket roll 400.

The lottery central system 200 can be any suitable lottery central system. For this illustrated example embodiment, the configuration, and functions of the lottery central system 200 does not need to change from the conventional configuration and functions of a lottery ticket printer, and is thus not described herein for brevity.

Turning now to FIG. 6, part of an example printed lottery ticket roll 600 is shown. In various embodiments, the printed lottery ticket roll 600 corresponds to the printed lottery ticket roll 400, as described above. The example printed lottery ticket roll 600 includes: (1) a plurality of draw lottery tickets, including draw lottery tickets 602a, 602b, 602c, and 602d; and (2) printed location data 604. In the example shown in FIG. 6, the printed location data 604 is encoded as a QR code and interleaved between the plurality of lottery tickets (i.e., between the third and fourth lottery tickets 602c and 602d). For the example printed lottery ticket roll 600, the printed location data is interleaved after every third lottery ticket. That is, the printed location data 604 includes location data for the three draw lottery tickets 602a, 602b, and 602c, a second, different section of printed location data (not shown) includes location data for a next three draw lottery tickets (i.e., the draw lottery ticket 602d and two additional draw lottery tickets), etc. It should be appreciated that the present disclosure contemplates that other layouts of printed draw lottery tickets and printed location data can be employed in accordance with the present disclosure.

Turning now to FIG. 7, an example method 700 of operating the lottery ticket selling system 100 is now described. Although the method is described with reference to the flowchart shown in FIG. 7, other methods of performing the acts associated with this illustrated process may be employed. For example, the order of certain of the illustrated blocks and diamonds may be changed, certain of the illustrated blocks and diamonds may be optional, or certain of the illustrated blocks and diamonds may not be employed.

In this example system and method for printing multiple draw lottery tickets for a draw lottery game, the lottery terminal 140 determines a plurality of draw lottery tickets, as indicated at block 702. In various embodiments, the lottery terminal 140 receives ticket information for each of multiple draw lottery tickets. For example, the lottery terminal 140 receives one or more play slips (e.g., physical paper play slips, digital play slip image data, and/or electronic play slips) for the draw lottery game, as described above. In various embodiments, the lottery terminal 140 also communicates with the lottery central system 200, for example, to determine the draw lottery tickets, determine player numbers for a quick pick, etc.

In various embodiments, the operator of the lottery terminal 140 also collects the payment for the draw lottery ticket from the courier service and provides the printed lottery ticket roll to a courier processing clerk. The courier processing clerk then takes the printed lottery ticket roll back to the courier processing center and scans each of the printed lottery tickets on the printed lottery ticket roll using a courier scanning system connected to the courier server 130. In various embodiments, the courier server 130 includes or is communicatively coupled with the lottery ticket retrieval device 180 for scanning the printed lottery tickets. The courier server 130 links each of the scanned draw lottery tickets back to the player (or player account established through the courier mobile application). The courier server 130 makes each of the scanned draw lottery tickets available for the associated player to view via the courier mobile application on the player's mobile electronic device. The courier processing clerk places the printed lottery ticket roll in a secure courier storage location for storage if needed by the player or the courier service at a later time such as discussed above.

In this example method, the lottery terminal 140 tracks location data for the plurality of draw lottery tickets, as indicated at block 704. As described above, the location data indicates which draw lottery tickets are printed on the printed lottery ticket roll and a location at which those draw lottery tickets can be retrieved. In this example, the location data includes a QR code that indicates, for each draw lottery ticket, a ticket serial number and a ticket index for that ticket.

In this example, the lottery terminal 140 causes the lottery ticket printer 150 to print the plurality of draw lottery tickets on the printed lottery ticket roll 400, as indicated at block 706. That is, the lottery terminal 140 causes the lottery ticket printer 150 to print out the multiple draw lottery tickets, each with player numbers, on the same printed lottery ticket roll. In various embodiments, the lottery terminal 140 generates ticket printer data based on the ticket information and provides the ticket printer data to lottery ticket printer 150 for printing the draw lottery tickets such as described above. In this example, the lottery terminal 140 causes the lottery ticket printer 150 to print the location data at an end of the printed lottery ticket roll 400. That is, the lottery ticket printer 150 prints the QR code such as described above.

In this example, the lottery ticket roll handling device 160 winds the printed lottery ticket roll 400 for storage, as indicate at block 708. To improve handling efficiency of the printed lottery ticket roll 400, for example, the lottery ticket roll handling device 160 winds the printed lottery ticket roll 400 around the removable spool 402. In various embodiments, the printed lottery ticket roll 400 is then stored in the secure courier storage location such as described above.

In this example, the printed lottery ticket roll 400 includes a winning draw lottery ticket, a courier processing clerk obtains the printed lottery ticket roll 400 from storage, and installs the printed lottery ticket roll 400 onto the lottery ticket retrieval device 180. The lottery ticket retrieval device 180 receives the printed lottery ticket roll 400 and ticket identifying information, as indicated at block 710. In this example, the ticket identifying information is associated with the winning draw lottery ticket and is received from the courier server 130. In other embodiments, the lottery ticket retrieval device 180 can receive the ticket identifying information from the lottery terminal 140 or via manual entry by the courier processing clerk. In various embodiments, the ticket identifying information can include one or more of a ticket identifier, a set of player numbers, or other suitable identifying information associated with the winning draw lottery ticket.

The lottery ticket retrieval device 180 retrieves the winning draw lottery ticket from the printed lottery ticket roll 400, as indicated at block 712. That is, the lottery ticket retrieval device 180 locates the winning draw lottery ticket within the printed lottery ticket roll 400 and advances the winning draw lottery ticket to the ticket retrieval location.

In various embodiments, the lottery ticket retrieval device 180 can cut the winning lottery ticket from the printed lottery ticket roll 400 using the ticket cutter as described above. In various embodiments, the lottery ticket retrieval device 180 winds a remainder of the printed lottery ticket roll 400 around a spool for storage. In some scenarios when the winning draw lottery ticket is cut from a middle of the printed lottery ticket roll 400, cutting of the printed lottery ticket roll 400 creates two separate rolls. In some embodiments, the lottery ticket retrieval device 180 is configured to wind both rolls together to simplify storage and handling. That is, the lottery ticket retrieval device 180 winds a first roll onto a spool and winds a second roll around the first roll. In some embodiments, the lottery ticket retrieval device 180 winds the separate rolls onto separate spools.

In various embodiments and/or scenarios, such as when location data is not tracked or not available, the lottery ticket retrieval device 180 is configured to scan the printed lottery tickets individually. That is, the lottery ticket retrieval device 180 scans a printed draw lottery ticket on the printed lottery ticket roll 400 and advances to a next printed draw lottery ticket for another scan until the winning draw lottery ticket is located. In various other embodiments, the lottery ticket retrieval device 180 receives the location data (e.g., from storage or by scanning the printed location data) and advances the printed lottery ticket roll 400 to the winning draw lottery ticket using the location data.

In various embodiments, the lottery terminal 140 combines draw lottery tickets associated with multiple play slips onto a same printed lottery ticket roll 400. In certain such embodiments, the combined draw lottery tickets include tickets purchased by and/or purchased for multiple different ticket purchasers.

In various embodiments and/or scenarios, the paper roll 420 and/or the printed lottery ticket roll 400 are wound around multiple spools at the same time and/or different times. In various embodiments, the paper roll 420 is unwound from a first, supply spool for printing of draw lottery tickets on the roll and wound around a second, storage spool after printing for storage of the printed lottery ticket roll 400. In various embodiments, during printing, an unprinted portion of the paper roll 420 is wound on the supply spool while a printed portion is wound on the storage spool. In various embodiments, the printed lottery ticket roll 400 is unwound from the storage spool for removal of a draw lottery ticket and a remainder of the printed lottery ticket roll 400 is wound around a third spool for further storage.

In the example embodiments described above, the lottery terminal 140 and/or the lottery ticket retrieval device 180 track the location data. In other embodiments, the lottery ticket printer 150 is configured to track the location data and appends the location data to the printed lottery ticket roll 400. In various embodiments, the lottery ticket printer 150 tracks the location data for the draw lottery tickets while printing those draw lottery tickets to the printed lottery ticket roll 400 and then prints the location data at an end of the printed lottery ticket roll 400. In various embodiments, the lottery ticket printer 150 tracks the location data for up to a threshold number of draw lottery tickets (e.g., a predetermined number of tickets or until a location data buffer is filled), prints the location data to the printed lottery ticket roll 400, and then continues printing draw lottery tickets and tracking the location data for a next group of draw lottery tickets.

It should be appreciated from the above that these various example embodiments of the present disclosure provide a series of advantages that enable a reduction in use of paper and printing supplies and simplified location of printed draw lottery tickets. The advantages include but are not limited to the following advantages: (a) the courier service not having to physically handle individual printed lottery tickets; (b) the courier service not having to manually inspect each printed lottery ticket to locate a winning lottery ticket; (c) being able to locate a winning printed lottery ticket based on the identification of the roll that the winning printed lottery ticket is on; (d) using scanning instead of thumbing through tickets to find a winning printed lottery ticket; and (e) reducing wear on the lottery ticket printers because such printers do not need to cut such tickets.

It should be appreciated from the above that various embodiments of the present disclosure provide a lottery ticket printing system comprising: a supply paper roll holder configured to support a removable lottery ticket paper roll; a lottery ticket printer; and a lottery ticket terminal configured to: determine a plurality of draw lottery tickets; and cause the lottery ticket printer to print the plurality of draw lottery tickets in a form of a printed lottery ticket roll using a lottery ticket paper roll supported by the supply paper roll holder. In various such embodiments, the printed lottery ticket roll comprises a continuous strip of lottery ticket paper. In various such embodiments, the plurality of draw lottery tickets printed on the printed lottery ticket roll comprise draw lottery tickets for a plurality of ticket purchasers. In various such embodiments, the lottery ticket printing system is configured to: track location data that identifies locations on the printed lottery ticket roll associated with retrieval of the plurality of draw lottery tickets; and provide the location data to a ticket retrieval device configured to retrieve a winning draw lottery ticket of the plurality of draw lottery tickets from the printed lottery ticket roll based on the location data. In various such embodiments, the lottery ticket printing system comprises the ticket retrieval device, wherein the lottery ticket terminal is configured to store the location data and the ticket retrieval device is configured to retrieve the winning draw lottery ticket from the printed lottery ticket roll based on the stored location data and ticket identifying information for the winning draw lottery ticket of the plurality of draw lottery tickets. In various such embodiments, the ticket retrieval device comprises a ticket cutter and roll engagers configured to advance the printed lottery ticket roll; and the ticket retrieval device is configured to cause the roll engagers to align the winning draw lottery ticket with the ticket cutter based on the stored location data, and cause the ticket cutter to cut the winning draw lottery ticket from the printed lottery ticket roll. In various such embodiments, the lottery ticket terminal is configured to cause the lottery ticket printer to print the plurality of draw lottery tickets and the location data in the form of the printed lottery ticket roll, wherein the printed location data on the printed lottery ticket roll is scannable by the ticket retrieval device. In various such embodiments, the lottery ticket printing system comprises the ticket retrieval device, the ticket retrieval device comprises a location data reader configured to scan printed location data, and the ticket retrieval device stores is configured to: cause the location data reader to scan printed location data from the printed lottery ticket roll, receive scanned location data that is based on the printed location data scanned by the location data reader, and retrieve the winning draw lottery ticket from the printed lottery ticket roll based on the scanned location data and ticket identifying information for the winning draw lottery ticket of the plurality of draw lottery tickets. In various such embodiments, the printed location data on the printed lottery ticket roll is interleaved with the printed plurality of draw lottery tickets. In various such embodiments, the location data comprises an index of the printed plurality of draw lottery tickets on the printed lottery ticket roll.

It should further be appreciated from the above that various embodiments of the present disclosure provide a lottery ticket retrieval device comprising: a housing; roll engagers supported by the housing and configured to advance a printed lottery ticket roll, wherein the printed lottery ticket roll comprises a plurality of printed draw lottery tickets; a controller configured to: receive ticket identifying information for a winning draw lottery ticket of the plurality of printed draw lottery tickets, and locate the winning draw lottery ticket on the printed lottery ticket roll, comprising causing the roll engagers to advance the printed lottery ticket roll to align the winning draw lottery ticket with a ticket retrieval location. In various such embodiments, the lottery ticket retrieval device comprises a ticket cutter configured to cut lottery tickets aligned with the ticket retrieval location, and the lottery ticket retrieval device is configured to cause the ticket cutter to cut the winning draw lottery ticket from the printed lottery ticket roll when the winning draw lottery ticket is aligned with the ticket retrieval location. In various such embodiments, the lottery ticket retrieval device is configured to: receive location data that identifies locations on the printed lottery ticket roll associated with retrieval of the plurality of draw lottery tickets, and cause the roll engagers to advance the winning draw lottery ticket on the printed lottery ticket roll to the ticket retrieval location based on the received location data and the ticket identifying information. In various such embodiments, the lottery ticket retrieval device includes a location data reader supported by the housing and configured to scan printed location data, and is configured to: cause the location data reader to scan printed location data from the printed lottery ticket roll, receive scanned location data that is based on the printed location data scanned by the location data reader, and cause the roll engagers to advance the winning draw lottery ticket on the printed lottery ticket roll to the ticket retrieval location based on the scanned location data and the ticket identifying information. In various such embodiments, the lottery ticket retrieval device comprises a location data reader supported by the housing and configured to scan printed location data from a scan region, and is configured to: cause the location data reader to scan printed location data from a first location data section of the printed lottery ticket roll, wherein the printed lottery ticket roll comprises printed location data at location data sections that are interleaved with the plurality of printed draw lottery tickets, receive scanned location data that is based on the printed location data scanned by the location data reader, cause the roll engagers to advance a second location data section of the printed lottery ticket roll to the scan region when the scanned location data is not associated with the location of the winning draw lottery ticket on the printed lottery ticket roll, and cause the roll engagers to advance the winning draw lottery ticket on the printed lottery ticket roll to the ticket retrieval location when the scanned location data is associated with a location of the winning draw lottery ticket on the printed lottery ticket roll. In various such embodiments, the lottery ticket retrieval device includes a lottery ticket data reader supported by the housing and configured to scan a printed draw lottery ticket within a scan region, and is configured to: cause the lottery ticket data reader to scan a printed draw lottery ticket on the printed lottery ticket roll, receive scanned lottery ticket data that is based on the printed draw lottery ticket scanned by the lottery ticket data reader, cause the roll engagers to advance a next printed draw lottery ticket to the scan region when the scanned lottery ticket data is not associated with the winning draw lottery ticket, and cause the roll engages to advance the winning draw lottery ticket to the ticket retrieval location when the scanned lottery ticket data is associated with the winning draw lottery ticket.

It should further be appreciated from the above that various embodiments of the present disclosure provide a lottery ticket selling system comprising: a lottery ticket printer; and a lottery ticket terminal configured to: determine a plurality of draw lottery tickets for a plurality of different players; and cause the lottery ticket printer to print the plurality of draw lottery tickets in a form of a printed lottery ticket roll using a lottery ticket paper roll. In various such embodiments, the printed lottery ticket roll comprises a continuous strip of lottery ticket paper. In various such embodiments, the lottery ticket printing system is configured to create location data that identifies locations on the printed lottery ticket roll associated with each of the plurality of draw lottery tickets. In various such embodiments, the lottery ticket printing system is configured to cause the lottery ticket printer to print ticket location indicators on the printed lottery ticket roll and that associated with each of the plurality of draw lottery tickets.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket printing system comprising:
a supply paper roll holder configured to support a removable lottery ticket paper roll;
a lottery ticket printer; and
a lottery ticket terminal comprising a processor and a memory device that stores a plurality of instructions, which when executed by the processor cause the processor to:
determine a plurality of draw lottery tickets; and
cause the lottery ticket printer to print the plurality of draw lottery tickets in a form of a printed lottery ticket roll using a lottery ticket paper roll supported by the supply paper roll holder.

2. The lottery ticket printing system of claim 1, wherein the printed lottery ticket roll comprises a continuous strip of lottery ticket paper.

3. The lottery ticket printing system of claim 2, wherein the plurality of draw lottery tickets printed on the printed lottery ticket roll comprise draw lottery tickets for a plurality of ticket purchasers.

4. The lottery ticket printing system of claim 1, wherein the memory device stores instructions, which when executed by the processor cause the processor to:
track location data that identifies locations on the printed lottery ticket roll associated with retrieval of the plurality of draw lottery tickets; and
provide the location data to a ticket retrieval device configured to retrieve a winning draw lottery ticket of the plurality of draw lottery tickets from the printed lottery ticket roll based on the location data.

5. The lottery ticket printing system of claim 4, which comprises the ticket retrieval device, the ticket retrieval device comprising a processor and a memory device that stores a plurality of instructions;
wherein the memory device of the lottery ticket terminal stores instructions, which when executed by the processor of the lottery ticket terminal cause the processor to store the location data;
wherein the memory device of the ticket retrieval device stores instructions, which when executed by the processor of the ticket retrieval device cause the processor to retrieve the winning draw lottery ticket from the printed lottery ticket roll based on the stored location data and ticket identifying information for the winning draw lottery ticket of the plurality of draw lottery tickets.

6. The lottery ticket printing system of claim 5, wherein:
the ticket retrieval device comprises a ticket cutter and roll engagers configured to advance the printed lottery ticket roll; and
wherein the memory device of the ticket retrieval device stores instructions, which when executed by the processor of the ticket retrieval device cause the processor to cause the roll engagers to align the winning draw lottery ticket with the ticket cutter based on the stored location data, and cause the ticket cutter to cut the winning draw lottery ticket from the printed lottery ticket roll.

7. The lottery ticket printing system of claim 4, wherein the memory device of the lottery ticket terminal stores instructions, which when executed by the processor of the lottery ticket terminal cause the processor to cause the lottery ticket printer to print the plurality of draw lottery tickets and the location data in the form of the printed lottery ticket roll, wherein the printed location data on the printed lottery ticket roll is scannable by the ticket retrieval device.

8. The lottery ticket printing system of claim 7, which comprises the ticket retrieval device, the ticket retrieval device comprising a location data reader configured to scan printed location data; wherein the memory device of the ticket retrieval device stores instructions, which when executed by the processor of the ticket retrieval device cause the processor to:
cause the location data reader to scan printed location data from the printed lottery ticket roll,
receive scanned location data that is based on the printed location data scanned by the location data reader, and
retrieve the winning draw lottery ticket from the printed lottery ticket roll based on the scanned location data and ticket identifying information for the winning draw lottery ticket of the plurality of draw lottery tickets.

9. The lottery ticket printing system of claim 8, wherein the printed location data on the printed lottery ticket roll is interleaved with the printed plurality of draw lottery tickets.

10. The lottery ticket printing system of claim 4, wherein the location data comprises an index of the printed plurality of draw lottery tickets on the printed lottery ticket roll.

11. A lottery ticket retrieval device comprising:
a housing;
roll engagers supported by the housing and configured to advance a printed lottery ticket roll, wherein the printed lottery ticket roll comprises a plurality of printed draw lottery tickets;
a controller including a processor and a memory device that stores a plurality of instructions, which when executed by the processor cause the processor to:
receive ticket identifying information for a winning draw lottery ticket of the plurality of printed draw lottery tickets, and
locate the winning draw lottery ticket on the printed lottery ticket roll, comprising causing the roll engagers to advance the printed lottery ticket roll to align the winning draw lottery ticket with a ticket retrieval location.

12. The lottery ticket retrieval device of claim 11, which comprises a ticket cutter configured to cut lottery tickets aligned with the ticket retrieval location, and wherein the memory device stores instructions, which when executed by the processor cause the processor to cause the ticket cutter to cut the winning draw lottery ticket from the printed lottery ticket roll when the winning draw lottery ticket is aligned with the ticket retrieval location.

13. The lottery ticket retrieval device of claim 11, wherein the memory device stores instructions, which when executed by the processor cause the processor to: receive location data that identifies locations on the printed lottery ticket roll associated with retrieval of the plurality of draw lottery tickets, and cause the roll engagers to advance the winning draw lottery ticket on the printed lottery ticket roll to the ticket retrieval location based on the received location data and the ticket identifying information.

14. The lottery ticket retrieval device of claim 11, which comprises a location data reader supported by the housing and configured to scan printed location data, wherein the memory device stores instructions, which when executed by the processor cause the processor to:
cause the location data reader to scan printed location data from the printed lottery ticket roll,
receive scanned location data that is based on the printed location data scanned by the location data reader, and
cause the roll engagers to advance the winning draw lottery ticket on the printed lottery ticket roll to the ticket retrieval location based on the scanned location data and the ticket identifying information.

15. The lottery ticket retrieval device of claim 11, which comprises a location data reader supported by the housing and configured to scan printed location data from a scan region, wherein the memory device stores instructions, which when executed by the processor cause the processor to:
cause the location data reader to scan printed location data from a first location data section of the printed lottery ticket roll, wherein the printed lottery ticket roll comprises printed location data at location data sections that are interleaved with the plurality of printed draw lottery tickets,
receive scanned location data that is based on the printed location data scanned by the location data reader,
cause the roll engagers to advance a second location data section of the printed lottery ticket roll to the scan region when the scanned location data is not associated with the location of the winning draw lottery ticket on the printed lottery ticket roll, and
cause the roll engagers to advance the winning draw lottery ticket on the printed lottery ticket roll to the ticket retrieval location when the scanned location data is associated with a location of the winning draw lottery ticket on the printed lottery ticket roll.

16. The lottery ticket retrieval device of claim 11, which comprises a lottery ticket data reader supported by the housing and configured to scan a printed draw lottery ticket within a scan region, wherein the memory device stores instructions, which when executed by the processor cause the processor to:
cause the lottery ticket data reader to scan a printed draw lottery ticket on the printed lottery ticket roll,
receive scanned lottery ticket data that is based on the printed draw lottery ticket scanned by the lottery ticket data reader,
cause the roll engagers to advance a next printed draw lottery ticket to the scan region when the scanned lottery ticket data is not associated with the winning draw lottery ticket, and
cause the roll engages to advance the winning draw lottery ticket to the ticket retrieval location when the scanned lottery ticket data is associated with the winning draw lottery ticket.

17. A lottery ticket selling system comprising:
a lottery ticket printer; and
a lottery ticket terminal comprising a processor and a memory device that stores a plurality of instructions, which when executed by the processor cause the processor to:
determine a plurality of draw lottery tickets for a plurality of different players; and
cause the lottery ticket printer to print the plurality of draw lottery tickets in a form of a printed lottery ticket roll using a lottery ticket paper roll.

18. The lottery ticket selling system of claim 17, wherein the printed lottery ticket roll comprises a continuous strip of lottery ticket paper.

19. The lottery ticket printing system of claim 17, wherein the memory device stores instructions, which when executed by the processor cause the processor to create location data that identifies locations on the printed lottery ticket roll associated with each of the plurality of draw lottery tickets.

20. The lottery ticket printing system of claim 17, wherein the memory device stores instructions, which when executed by the processor cause the processor to cause the lottery ticket printer to print ticket location indicators on the printed lottery ticket roll and that associated with each of the plurality of draw lottery tickets.
